(19) United States
(12) Patent Application Publication
(10) Pub. No.: US 2004/0101699 A1
(43) Pub. Date: May 27, 2004

(54) Heat insulating layer based on la2zr2o7 for high temperatures

(76) Inventors: Robert Vassen, Herzogenrath (DE); Henry Bosch, Stuttgart (DE); Markus Dietrich, Bruchkobel (DE); Xueqiang Cao, Changsha,Hunan (CN); Detlev Stover, Niederzier (DE); Gerhard Pracht, Julich (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/474,173

(22) PCT Filed: Mar. 12, 2002
(86) PCT No.: PCT/DE02/01355

(30) Foreign Application Priority Data
Apr. 3, 2001 (DE) 101-16-597.8
Nov. 29, 2001 (DE) 101-58-639.6

(51) Int. Cl. B32B 15/04; C23C 4/00; C23C 30/00

(52) U.S. Cl. 428/472

(57) ABSTRACT

The invention relates to a heat insulating layer on a metallic substrate for using for high temperatures, especially for temperatures above 1300° C. Starting with a base of La₂Zr₂O₇, the properties of the heat insulating substance to be used as the heat insulating layer are regularly improved, by substituting lanthanum cations with ions of elements Nd, Eu, Dy, Sm and/or Gd. An additional, at least partial substitution of the zirconium cations by Ce, Hf or Ta is advantageous. Improving the properties results especially in a high thermal coefficient of dilation α and low heat conductivity λ.

The invention relates to a heat insulating layer for high temperatures, especially for temperatures above 1300° C., on the basis of La₂Zr₂O₇.

### STATE OF THE ART

Heat insulating materials for high temperatures are used for example in gas turbines of aircraft engines and thermal power plants to protect the hot parts and thus especially the turbine blades and combustion chambers from the high thermal loads of the hot gases. The heating insulating layers are subjected to extremely high temperatures during the operating periods of the turbine which can amount to several hours at peak load operations for up to a year in base load operation. The thermal efficiency of gas turbines depends on the turbine entry temperature of the combustion gases which nowadays lies above of 1300° C. Higher gas temperatures of 1400° C. more can indeed be produced but are not usable at the present time since the known materials which are employed for the hot parts do not have sufficient stability for long durations at elevated temperatures in excess of 1200° C. At the present time, the best results are produced with components which are directionally solidified or, still better, have superalloys of a monocrystalline nickel basis as the substrate and upon which a thermal insulating layer is applied which is comprised of ZrO₂ (zirconium dioxide) partly stabilized by the addition of yttrium oxide (Y₂O₃) which is known by the designation YSZ.

At higher surface temperatures, for example, 1300° C. and more, however, there is a postsintering of the YSZ layer which gives rise to a deterioration of the thermomechanical properties, as for example, an increase in the thermal conductivity as well as of the modulus of elasticity and a reduction in the quasi plastic characteristics by the sintering of the crack network.

Furthermore, a difficulty resides in that there is an increase in the surface temperature of the thermal insulation at the same layer thicknesses of the thermal insulation and the same thermal conductivity of this layer as well as an increase of the temperature of the metal substrate lying therebeneath which can result in a significant reduction in the life of the component.

As a consequence, there is interest in a replacement for thermal insulation materials of YSZ, above all, by materials which have a reduced thermal conductivity by comparison with the YSZ, like, for example, La₂Zr₂O₇. The zirconate has, however, the disadvantage that by comparison to metallic components, it has only a limited thermal expansion coefficient which can give rise a rule with alterations in the thermal loading to stress induced failure mechanisms.

In JP-A-07 292 453, a thermal insulating coating is disclosed which serves, in the case of metal parts which are in contact with hot gases, like for example, the rotor blades and the guide blades of gas turbines, to protect them against high temperature oxidation. These thermal insulating coatings are applied to the metal parts in that essentially these metal parts are coated using low pressure plasma spraying with MCrAlY, (where M stands for Ni and/or Co), in that then this coating is coated with ZrOz-Y₂O₃ using atmospheric plasma spraying, and in that finally an inorganic glazing is painted onto the ZrO₂—Y₂O₃ layer and then fired or directly thermally sprayed on.

SU-A 305 152 discloses a refractory cement which contains strontium aluminate and strontium zirconate. The cement is so constituted that it contains a mixture of 46.15 to 46.62 weight % SrO, 43.46 to 48.89 weight % ZrO₂ and 4.96 to 9.92 weight % Al₂O₃′ which is fired at 1400 to 1500° C. The resulting cement contains 10 to 20 weight % SrOAl₂O₃ and 80 to 90% by weight SrOZrO₂ and melts at 2200° to 2300° C.

JP-A-50 035 011 discloses a refractory coating for transport rollers in a bright annealing furnace in which calcium zirconate is used to protect the rollers against iron oxide. This coating is so fabricated that the rollers are coated using plasma spraying of Ni—Cr powder of a mixture of 70 weight % Ni—Cr and 30 weight % CaZrO₃ and with CaZrO₃ powder in succession. It has been found that this coating is not attacked by iron oxide whereas rollers which are coated with Al₂O₃, Al₂MgO₄, ZrO₂ or MgZrO₃ undergo a significant reaction with iron oxides.

DE-A-4210 397 discloses a temperature sensor for combustion gases which is comprised of SrZrO₃ and which is applied by sputtering or screen printing to a substrate.

In DE 198 01 424, oxides with a pyrochlor structure or perovskite structure are proposed as heat insulating materials which can be used at temperatures above 1000° C. The heat insulating materials there mentioned are substantially a zirconate or a mixture of zirconates. There are described especially BaZrO₃₁ La₂Zr₂O₇ and SrZrO₃.

From WO 01/23 642 A2, a metallic turbine component with a thermally insulating coating thereon of, for example, La₂Hf₂O. Between the component and the thermally insulating layer, a metallic MCrAlY alloy layer is disposed as a sublayer (M=Fe, Co Ni as well as mixtures thereof).

In WO 99/23270, a product with a layer system for protection against a hot aggressive gas is disclosed. The layer system encompasses an adhesion layer of MCrAlY alloy (M=Fe, Co, Ni as well as mixtures thereof), with 0.1 to 10% lanthanum and 0 to 10% hafnium. As specific thermal insulating layers, La₂Zr₂O₇ and La₂Hf₂O₇ among others are mentioned.

Objects and Solutions

It is an object of the present invention to provide further especially suitable heat insulating layers on the surface of a metal substrate which can be used at higher temperatures, especially above 1300° C. and which have a greater thermal coefficient of expansion than pure La₂Zr₂O₇.

This object is achieved with a thermal insulating layer with the totality of the features of the main claim. The object is thus achieved by further heat insulating layers with the totality of the features according to one of the dependent claims 3, 6 and 8. Advantageous features of the thermal insulating layer can be found in the dependent claims which relate back to them.

### SUBJECT OF THE INVENTION

The subject of the present invention is a thermal insulating layer which is arranged on the surface of a metal substrate and which is based upon La₂Zr₂O₇ which has the general formula A₂B₂O₇ and is crystallized in a pyrochlore structure. With the thermal insulating layer of the invention according to claim 1, the cations of the A position, i.e. the lanthanum are completely or at least partly substituted. Suitable cations for the substitution for lanthanum are thus the rare earth elements neodymium (Nd), dysprosium (Dy), europium (Eu) and samarium (Sm).

It has been found surprisingly in the framework of the invention that by a partial substitution of the Lanthanum in the A position by the rare earth elements Nd, Dy, Sm or Eu, with relatively low binding energy, the thermal expansion coefficient α can be advantageously increased.

It has been found to be especially advantageous with respect to the characteristics of the thermal insulating coatings when they are so defined that they are of an La₂Zr₂O₇ basis in which the B position, that is the zirconium, is completely or partly substituted by cerium (Ce), hafnium (Hf) or tantalum (Ta). Cerium assumes a separate position in that the La₂Ce₂O₇ when used in a thermal insulating coating crystallizes in a highly desirable fluorite structure. Such an advantageous thermal insulating layer is the subject of claim 3.

Within the framework of the invention, the term substitution should be so understood that at least 5% of the substituted element, especially the lanthanum and/or zirconium, is replaced by another element. Small quantities of foreign additives which result from the method of fabrication and typically are present in amounts up to 3 weight % can be present but are not meant when the term substitution is used. Furthermore, the term substitution is not intended to mean exclusively only a stoichiometric substitution. Especially in the case of the replacement of zirconium by cerium, a superstoichiometric substitution with up to 100% cerium excess is encompassed by the invention. Thus, for example, a layer of La_{1.96}, Ce_{2.04}O_{7.02} can be superimposed upon a YSZ layer. The fabrication of such a layer by plasma spraying can be provided as desired by including in the starting powder a higher cerium content toward the end of the layer formation.

A substitution of zirconium by cerium in the B place has the effect of a clear increase in the thermal expansion coefficient α. By the complete substitution of zirconium by hafnium, one can see practically no effect on the thermal expansion although it does yield in this system advantageously a reduction in the thermal conductivity λ in the case of a partial substitution. By a few tests this can be optimized by an appropriate variation of the Hf/Zr ratio. These have shown an advantage of Hf/Zr=1. A 50% substitution of zirconium by cerium or hafnium appears to be especially advantageous as a general matter in initial tests. According to theoretical considerations, the greatest effect should be with a 1:1 mixture, at least for the thermal conductivity λ.

This effect is also seen for other substituted thermal insulating compositions according to the invention and is based upon the strong scattering of the lattice oscillations in crystals with high mass differences. The inclusion of pentavalent heavy ions like tantalum is highly effective for the reduction of λ. Here because of the phase stability, however, only a substitution of a maximum of 18 mole % is possible since more no longer results in the formation of an advantageous pyrochlore structure.

Special Descriptive Part

Described are thermal insulating layers which on the one hand have a high thermal expansion coefficient α which is similar to those of a metallic substrate which can be protected by the thermal insulating layer and on the other hand have a reduced thermal conductivity λ to reduce heat transfer to the substrate as much as possible.

The present invention resides in optimization of the characteristics of the thermal insulating coating which is an oxide with the general empirical formula A₂B₂O₇, especially La₂Zr₂O₇ by substitution of the elements in the A and/or B positions.

The resulting heat insulating layer is a material with the general empirical formula A₂₋ₓA′ₓB_{2-y}B′_{y}O_{7±x} whereby x and y are each smaller than 2. In a special case B=Cerium and are y can be greater than 2. In the substitution of cations by cations with greater or smaller valences, there is a change in the number of oxygen ions per formula unit which is taken into consideration by the factor z. With such substitutions, there is especially a reduction in the thermal conductivity λ and in all cases an increase in the thermal expansion coefficient α.

Below the compositions of the material are given in detail.

Melting Temperature

Compounds with the empirical formula A₂B₂O₇ (where B=Zr, Hf, Ce or mixtures thereof), especially pyrochlores whose cations are namely 4d, 5d and 4f metals have a high melting point greater than 2000° C., for example Nd₂Zr₂O₇ and La₂Hf₂O₇. This property is namely a measure of the stability of the compound as well as in many cases an indication of a limited sinterability. A reduced sinterability in the thermal insulating layer is of advantage in order to maintain the porous microstructure of the layer. An influence of the substitution of cations on the high temperature resistance of the pyrochlores has not been observed heretofore.

Phase Stability of the Pyrochlore.

The described pyrochlores show no significant phase transformation below 1400° C. This phase stability is maintained in all cases even after the substitution of cations.

Thermal Conductivity (λ).

To produce an improved thermal insulation, new thermally insulating coating materials should have a smaller λ than that of the YSZ used today (2.2 W/mK). The thermal conductivity of a material cannot be precisely predicted today. The tendency toward a reduced thermal conductivity will depend upon complex structures, higher defect or vacancy concentrations in the structure and a large mass differences between cations and ions. For x=1 as a rule an especially good reduction in the thermal conductivity can be achieved. These conditions are fulfilled with pyrochlores with 4d, 5d and 4f cations in certain amounts. Thus the thermal conductivity λ in the case of La₂r₂O₇ is 1.6 W/mK and for a compound with 30% europium doping can be 1.2 W/mK.

By partial substitution of the cations with those of lesser or greater charge number, the defect concentration in the lattice can be increased which permits a lower thermal conductivity λ to be expected. By the substitution of 10 mole % of the zirconium by tantalum (La₂Zr_{1.9}Ta_{0.1}O₇), λ can be reduced by about a further 5% to 1.5 W/mK. Especially effective is the substitution of zirconium by cerium which in an extreme case can provide a value of about 1.2 W/mK.

Thermal Expansion Coefficient (α)

The thermal expansion coefficient of a material is not exactly predictable. From the tendency it increases however in general with increasing ionic radius, weaker bonding between cations and anions and a greater space filling of the structure. Thus the α of La₂Zr₂O₇ (9.1×1⁻⁶ K⁻¹) can be increased by substitution for the La of Nd to 10.1×10⁻⁶ K⁻¹ and by substitution by Ce of Zr to 10.3×19⁻⁶⁻¹ K.

Both increases are based upon the reduced bending energy. Still greater values of α can be expected with the substituents Sm and Eu which are in the 4f cation row and assured reduce bending energy to oxygen.

The better an element influences the characteristics of the pyrochlore the greater should its concentration be. In extreme cases the A and B lattice sites should be provided with the respective optimal elements so that one arrives at the simple pyrochlore A₂B₂O₇. Certain elements, like, for example, Eu, Sm and Ta, in the combination with zirconium or hafnium do not yield any pyrochlore structures or any such structures which undergo a phase transformation at elevated temperatures. In these cases, the proposed partial substitutions of the cations of stable pyrochlores additionally positively influence their characteristics. Encompassed by the invention are not only substances in the A sites and in the B cites, but also optional combinations of them. In this category, for example, are the compounds LaEuZrHfO₇, LaGdZrCeO₇, LaGdZr_{1.4}Ce_{0.6}O₇, and La_{1.8}Dy_{0.2}Zr_{1.4}Ce_{0.6}O₇. On general grounds, the occupation of the individual sites should, as a rule, provide the greatest mass difference for a reduced thermal conductivity.

### EXAMPLES

In the following several exemplary fabrication processes for the coating of a substrate with a thermal insulator according to the invention have been portrayed.

### Example A

### La₂Zr_{1.9}Ta_{0.1}O_{7.05} Thermal Insulation (WDS)

The La₂Zr_{1.9}Ta_{0.1}O_{7.05} is made by a solid phase reaction corresponding to the formula

La₂O₃+0.05Ta₂O₅+1.9ZrO₂-->La₂Sr_{1.9}Ta_{0.1}O_{7.05}

The starting powders are milled in a ball mill under ethanol and then brought to glowing reaction temperature at 1400° C. Then by spray drying a flowable powder is produced. First a bond promoting layer of an industrial available MCrAlY powder is applied to a substrate (Ni base alloy) by vacuum powder spraying (VPS). Then the pyrochlore layer is applied in a thickness of about 0.3 mm by means of air plasma spray (APS) on the bond promoting layer.

### Example B

### LaNdZr₂O₇ Thermal Insulating Coating

The LaNdZr₂O₇ powder is produced by spray drying an aqueous La(NO₃)₃, Nd(NO₃)₃ and Zr(NO₃)₂ solution with subsequent calcination at 1400° C. From this powder, ingots for an electron beam physical vapor deposition (EBPVD) processes were produced.

As the bond promoting coating (HVS), a vapor plasma sprayed and then smoothed coating or a plaque seen illuminable coating served. The substrate provided with the bond promoting coating was coated with the aid of LaZr₂O₇ by electron beam plasma spraying vapor deposition.

### Example C

### Multilayered or Graded Coating

Nd_{1.3}Sm_{0.7}Hf₂O₇ is produced like the La₂Zr_{1.9}Ta_{0.1}O_{7.05} in example A. By means of vapor plasma spraying a bond promoting coating of MCrAlY powder is applied to a substrate (nickel base alloy). On this bond promoting coating by means of plasma spraying YSZ layer is first applied and on that with the same method, an Nd_{1.3}Sm_{0.7}Hf₂O₇ layer is applied. In this manner, it is possible to spray the two oxides so that there is a continuous concentration gradient from YSZ to Nd_{1.3}Sm_{0.7}Hf₂O₇ and thus a graded thermal insulating coating. The subsequent table gives the properties of thermoconductivity λ and thermal expansion coefficient α for several selected thermal insulating compositions.

| | x, y | | Thermal Expansion | Thermal | |
|---|---|---|---|---|---|
| Formula | ranges | Example | Coefficient | Conductivity | Remarks |
| YSZ | | | 10,7 | 2,2 | SdT |
| BaZrO₃ | | BaZrO₃ | 7,9 | 3,60 | SdT |
| SrZrO₃ | | SrZrO₃ | 10,9 | — | SdT |
| La₂Zr₂O₇ | | La₂Zr₂O₇ | 8,9 bis 9,1 | 1,6 | SdT |
| La₂₋ₓGdₓZr₂O₇ | 0 < x ≦ 2 | La_{1,4}Gd_{0,6}Zr₂O₇ | 9,3 | — | SdT |
| | | Gd₂Zr₂O₇ | 10,5 | — | SdT |
| La₂₋ₓNdₓZr₂O₇ | 0 < x ≦ 2 | La_{1,4}Nd_{0,6}Zr₂O₇ | 8,7 | 1,36 | Insulation of |
| | | | | | the Invention |
| | | Nd₂Zr₂O₇ | 10,1 | 1,92 | Insulation of |
| | | | | | the Invention |
| La₂₋ₓEuₓZr₂O₇ | 0 < x ≦ 2 | La_{1,4}Eu_{0,6}Zr₂O₇ | 9,3 | 1,15 | Insulation of |
| | | | | | the Invention |
| La₂₋ₓDyₓZr₂O₇ | 0 < x ≦ 2 | La_{1,7}Dy_{0,3}Zr₂O₇ | 8,9 | 1,51 | Insulatior of |
| | | | | | the Invention |
| La₂Zr_{2-y}Ce_{y}O₇ | 0 < y ≦ 2 | La₂(Zr_{0,7}Ce_{0,3})₂O₇ | 9,5 | — | Insulation of |
| | | | | | the Invention |
| | | La₂(Zr_{0,3}Ce_{0,7})₂O₇ | 10,1 | — | Insulation of |
| | | | | | the Invention |
| | | La₂Ce₂O₇ | 10,3 | — | Insulation of |
| | | | | | the Invention |
| La₂Zr_{2-y}Hf_{y}O₇ | 0 < y ≦ 2 | La₂Hf₂O₇ | 8,2 | 1,8 | SdT |
| La₂Zr_{2-1,25y}Ta_{y}O₇ | 0 < y ≦ 0,16 | La₂Zr_{1,8}Ta_{0,16}O₇ | 8,7 | 1,41 | Insulation of |
| | | | | | the Invention |

1. A thermal insulating layer based upon La₂Zr₂O₇ which is disposed on the surface of a metallic substrate characterized by a 10 to 90% substitution of the lanthanum by neodymium, dysprosium, europium or samarium.

2. The thermal insulating layer according to the preceding claim 1 characterized by a 50% substitution of the lanthanum by neodymium, dysprosium, europium and samarium.

3. A thermal insulating layer based upon La₂Zr₂O₇ which is disposed on the surface of a metallic substrate especially according to claim 1 or 2, in which the zirconium is partly or completely substituted by cerium.

4. A thermal insulating layer according to a preceding claim in which the zirconium is substituted by cerium in a range of 5 to 95%, especially in a range of 40 to 60%.

5. A thermal insulating layer according to one of the preceding claims 1 to 4 in which the zirconium is superstoichiometrically substituted by cerium.

6. A thermal insulating layer based upon LaZr₂O₇ which is disposed on the surface of a metal substrate especially according to claim 1 or 2, in which the zirconium is partly substituted by hafnium.

7. A thermal insulating layer according to a preceding claim in which the zirconium is substituted by hafnium in a range of 5 to 95% especially in a range of 40 to 60%.

8. A thermal insulating layer based upon LaZr₂O₇ which is disposed on the surface of a metal substrate especially according to claim 1 or 2, in which the zirconium is partly substituted by tantalum.

9. A thermal insulating layer according to one of the preceding claims 1 to 8 with a 50% substitution of the zirconium by cerium or hafnium.

10. A thermal insulating layer according to one of the preceding claims 1 to 9 characterized by a thermal conductivity of less than 1.5 W/mK.
